(19) United States
(12) Patent Application Publication
(10) Pub. No.: US 2024/0065466 A1
(43) Pub. Date: Feb. 29, 2024

(54) ELECTRONIC PRESSURE COOKER LID WITH A PROTECTIVE SHIELD

(71) Applicant: Instant Brands Holdings Inc., Downers Grove, IL (US)

(72) Inventor: Jason LePinske, Schaumburg, IL (US)

(73) Assignee: Instant Brands Holdings Inc., Downers Grove, IL (US)

(21) Appl. No.: 17/895,579

(22) Filed: Aug. 25, 2022

(51) Int. Cl. A47J 27/09

(52) U.S. Cl. CPC A47J 27/09

(57) ABSTRACT

The present disclosure is directed to a lid for a cooking appliance with a protective shield. One form of a lid comprises a shield; a pressure release valve positioned on a first side of the shield, configured to move between an open position and a closed position; a switch positioned on a second side of the shield; a slider in communication with the switch; and a lever, where a first end of the lever is in communication with the pressure relief valve and a second end of the lever is in communication with the slider. The switch is configured to, when activated, move the slider such that the slider depresses the second end of the lever, thereby raising the first end of the lever and moving the pressure release valve from the closed position to the open position.

### BACKGROUND

Electric cooking appliances, such as electric pressure cookers (EPCs), are commonly used household appliances. A conventional EPC often includes an operation panel having push buttons disposed thereon for controlling operations of the cooking appliance. Using the operation panel, a consumer can operate the EPC to create a high pressure, high temperature environment inside a cooking vessel of the EPC to shorten cooking times. At a conclusion of a cooking cycle, the consumer must release pressurized gas, such as air and/or steam, from the cooking vessel of the EPC before accessing food contents therein. To that end, conventional EPCs include a pressure release valve designed to gradually release the pressurized gas from the cooking vessel. When the pressure release valve is opened, a plume of high-temperature and high-pressure air or steam is released from the EPC through the pressure release valve. To the average consumer, the released air and steam that exits the pressure release valve can be an intimidating process.

### SUMMARY

The present disclosure addresses the above-describe problem and provides a lid to an electric pressure cooker where a shield is positioned between a switch that a consumer activates to open a pressure release valve and the pressure release valve itself where pressurized gas is released from a cooking vessel of the EPC.

In one form, the present disclosure provides a lid for a cooking appliance that includes a pressure release valve, a slider, a switch, a lever, and a shield positioned on an exterior of the lid between the pressure release valve and the switch. The pressure release valve is configured to move between an open position and a closed position; the slider is configured to move between a first position and a second position; and the switch is in communication with the slider, wherein pressure on the switch in a first direction causes the slider to move between the first position and the second position.

The lever defines a first end and a second end, where the first end of the lever is in communication with the pressure release valve and the second end of the lever is in communication with the slider such that movement of the slider between the first position and the second position causes the second end of the lever to lower and the first end of the lever to raise, thereby moving the pressure release valve from the closed position to the open position.

In another form, a lid for a cooking appliance is provided that includes a shield positioned on an exterior of the lid, a pressure release valve, a switch, a slider, and a lever. The pressure release valve is positioned on the lid on a first side of the shield, where the pressure release valve configured to move between a closed position and an open position.

The switch is positioned on the lid on a second side of the shield that is opposite to the first side of the shield. The slider is in communication with the switch. The lever defines a first end and a second end, where the first end of the lever is in communication with the pressure relief valve and the second end of the lever is in communication with the slider.

The switch is configured to, when activated, move the slider such that the slider depresses the second end of the lever, thereby raising the first end of the lever and moving the pressure release valve from the closed position to the open position.

In yet another form, a pressure cooker comprising a cooker body, an interior pot positioned in an interior region of the cooker body, and a lid configured to couple with the cooker body is provided.

The lid comprises a shield positioned on an exterior of the lid, a pressure release valve, a switch, a slider, and lever. The pressure release valve is positioned on the lid on a first side of the shield, where the pressure release valve is in communication with the interior pot and the pressure release valve is configured to move between a closed position and an open position.

The switch is positioned on the lid on a second side of the shield that is opposite to the first side of the shield. The slider is in communication with the switch. The lever defines a first end and a second end, where the first end of the lever is in communication with the pressure release valve and the second end of the lever is in communication with the slider.

The switch is configured to, when activated, move the slider such that the slider depresses the second end of the lever, thereby raising the first end of the lever and moving the pressure release valve from the closed position to the open position.

### BRIEF DESCRIPTION OF THE DRAWINGS

Embodiments and implementations of the present disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is an exploded view of an electric pressure cooker.

FIG. 2 is a top view of a lid for an electric pressure cooker with a protective shield.

FIG. 3A is a perspective view of one form of a pressure release valve actuation system of a lid for an electronic pressure cooker with a protective shield.

FIG. 3B is a cross-sectional view of the pressure release valve along cross-sectional line I-I in FIG. 3A.

FIG. 4 is another perspective view of one form of a pressure release valve actuation system for an electronic pressure cooker with a protective shield.

FIG. 5 is a top view of components of one form of a pressure release valve actuation system for an electronic pressure cooker with a protective shield.

FIG. 6 is a perspective view of components of one form of a pressure release valve actuation system for an electronic pressure cooker with a protective shield.

FIG. 7 is another perspective view of components of one form of a pressure release valve actuation system for an electronic pressure cooker with a protective shield.

### DETAILED DESCRIPTION

As discussed below, the present disclosure provides a lid to an electric pressure cooker where a shield is positioned between a switch that a consumer activates to open a pressure release valve and the pressure release valve itself where pressurized air and/or steam is released from a cooking vessel of the EPC. Positioning a shield between a switch and a pressure release valve of an electric pressure cooker provides enhanced safety by providing a partial barrier between a hand of a user activating the switch and steam exiting the electric pressure cooker at the pressure release valve.

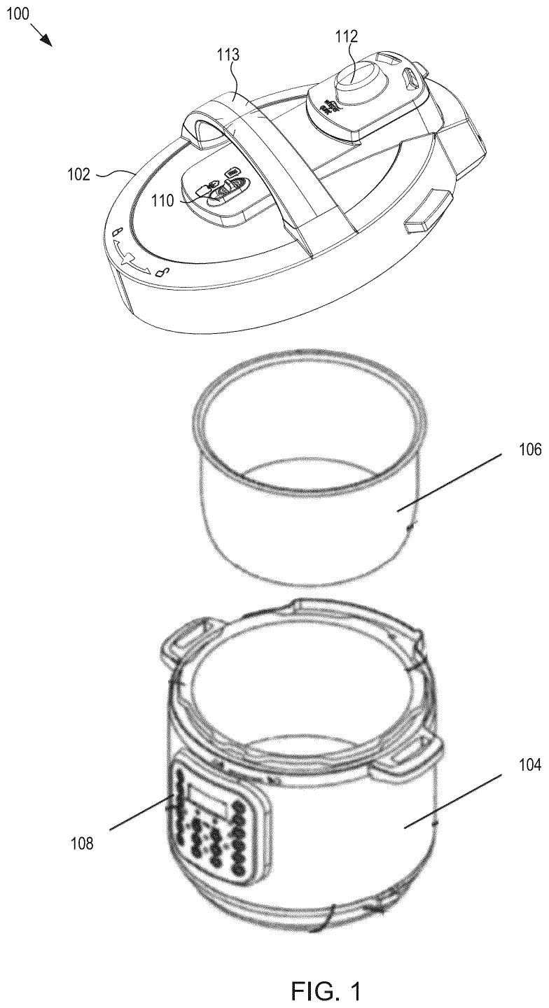

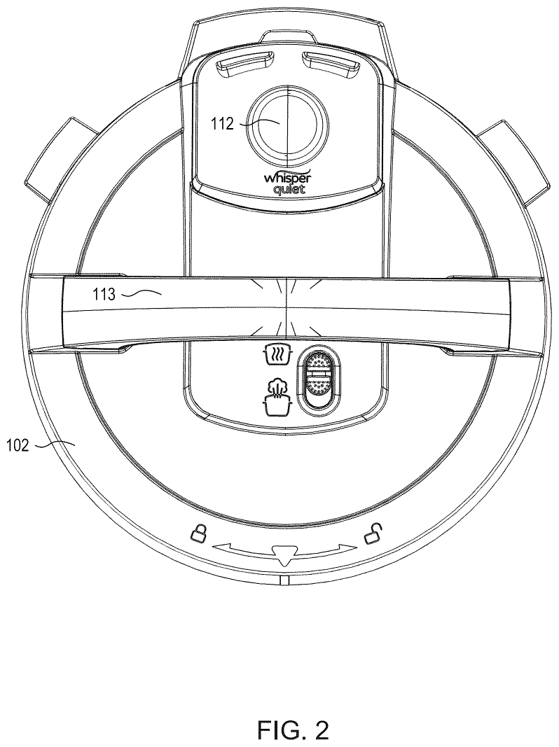

FIG. 1 is an exploded view of an electric pressure cooker 100 with a protective shield and FIG. 2 is a top view of a lid 102 for the electric pressure cooker with a protective shield. The pressure cooker 100 generally includes a lid 102, a cooker body 104, and an inner pot 106. The cooker body 104 may further include a control panel 108 positioned at a side of the cooker body 104. The control panel 108 is used to control operations of the pressure cooker 100. Through interactions with the control panel 108, the cooker body 104 heats food inside the inner pot 106 when the inner pot 106 is positioned inside an interior region of the cooker body 104. The lid 102 is configured to couple with the cooker body 104 when the inner pot 106 is positioned inside the cooker body 104 to form an air-tight environment and maintain pressure in the pressure cooker 100.

When a cooking operation is complete, a user may wait for the pressure and temperature in the pressure cooker 100 to subside, or the user can actuate a switch 110 to open a pressure release valve 112 positioned in an interior of the lid 102 and allow a rapid release of pressure. As shown in FIGS. 1 and 2, a shield 113, such as a handle, is positioned between the switch 110 and the pressure release valve 112 to provide a partial barrier between a hand of a user activating the switch 110 and steam exiting the electric pressure cooker at the pressure release valve 112.

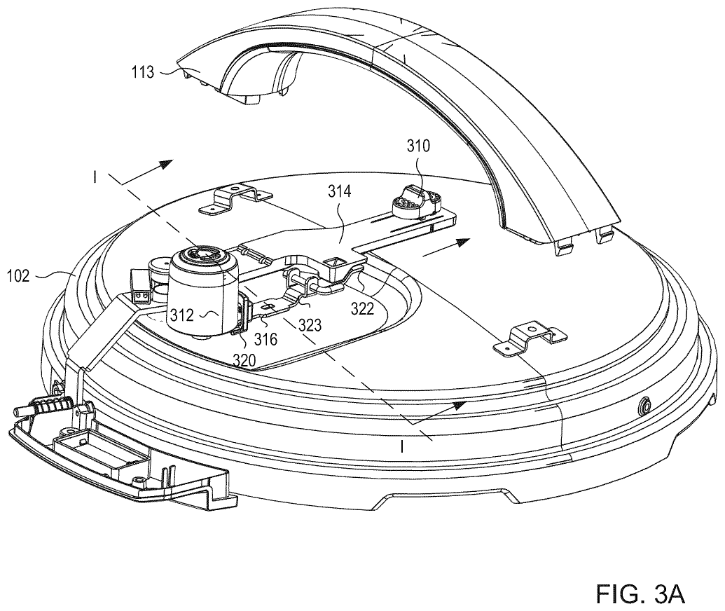

FIG. 3A is a perspective view of one form of a pressure release valve actuation system of a lid for an electronic pressure cooker with a protective shield. In FIG. 3A, a portion of an external casing of the lid has been removed to illustrate internal components such as the pressure release valve actuation system of the lid. The pressure release valve actuation system includes a switch 310, a pressure release valve 312, a slider 314, and a lever 316.

As explained in more detail below, in some implementations, the pressure release valve actuation system is configured such that when a user activates the switch 310 by placing pressure on the switch, the pressure creates movement of the slider 314, which causes the lever 316 to open the pressure release valve 312 so that pressurized gas is released from the electronic pressure cooker.

When the lid is coupled with the cooker body as described above, the pressure release valve 312 is in fluid communication with the inner pot via an airway stem 318 (See FIG. 3B). The pressure release valve 312 is configured to move between a first closed position and a second open position. In some implementation, the pressure release valve 312 is in a closed position when the pressure release valve 312 is in a natural resting position against the airway stem 318. In the closed position, the pressure release valve 312 obstructs the airway stem 318 and prevents the airway stem 318 from providing a channel for an airflow to and from the inner pot. When the pressure release valve 312 is raised to an open position, the pressure release valve 312 no longer obstructs the airway stem 318. In the open position, the pressure release valve 312 does not restrict the airway stem 318 such that the airway stem provides a channel for airflow to and from the inner pot.

The switch 310, the slider 314, and the lever 316 are configured to act in conjunction with each other to raise the pressure release valve 312 from the first closed position to the second open position. The slider 314 is positioned on the lid and configured to slide between a first position and a second position. In some implementations, the first position of the slider 314 is closer to the pressure release valve 312 than the second position.

The switch 310 is connected to the slider 314 such that when a user activates the switch 310 by putting pressure on the switch and pulling the switch in a first direction away from the pressure release valve 312, the slider 314 also moves from its first position to its second position away from the pressure release valve 312.

The lever 316 defines a first end 320 and a second end 322. The lever 316 is positioned on the lid to pivot at a pivot point 323 such that when the second end 322 of the lever 316 lowers, the first end 320 of the lever 316 raises. In some implementations, the second end 322 of the lever is in communication with a portion 316 of the slider 314 such that when the slider 314 moves from its first position to its second position, the movement of the slider 314 causes the second end 322 of the lever 316 to lower. As a result, the first end 320 of the lever is raised.

In some implementations, the first end 320 of the lever 316 is in communication with the pressure release valve 312 such that when the first end 320 raises as a result of the movement of the slider 316, the first end 320 of the lever 316 causes the pressure release valve 312 to move from its closed position to its open position.

While implementations of a pressure release valve actuation system have been described above with respect to relative movements of the switch 310, the pressure release valve 312, the slider 314, and the lever 316, one of skill in the art will appreciate that other configurations may be used with different relative movements of the switch 310, the pressure release valve 312, the slider 314, and the lever 316 that similarly result in activation of the switch 310 causing the pressure release valve to move from a closed position to an open position so that pressurized gas is released from the electronic pressure cooker.

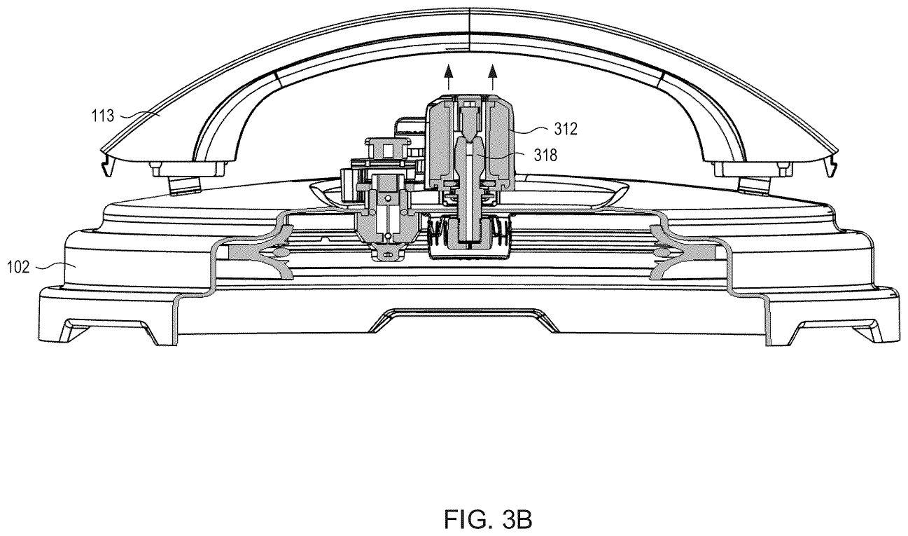

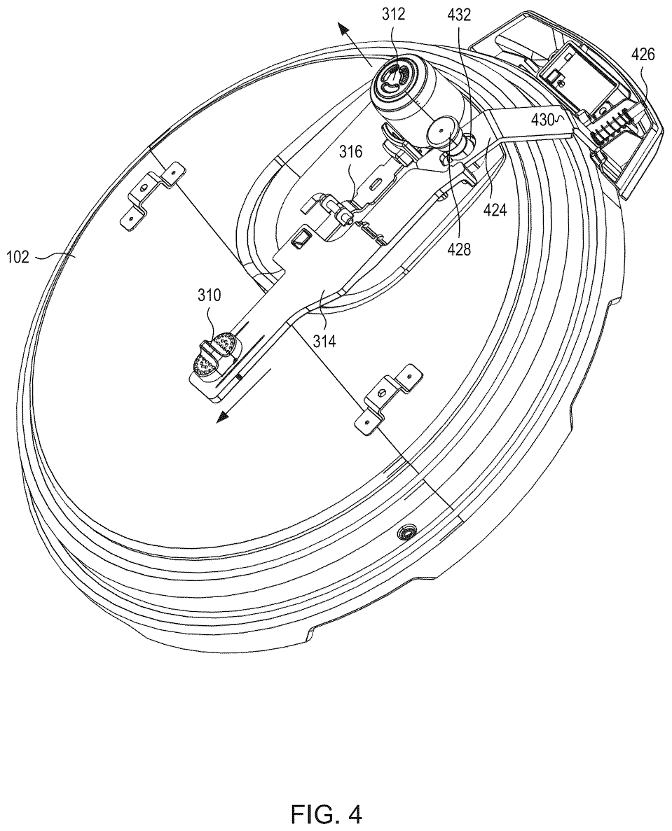

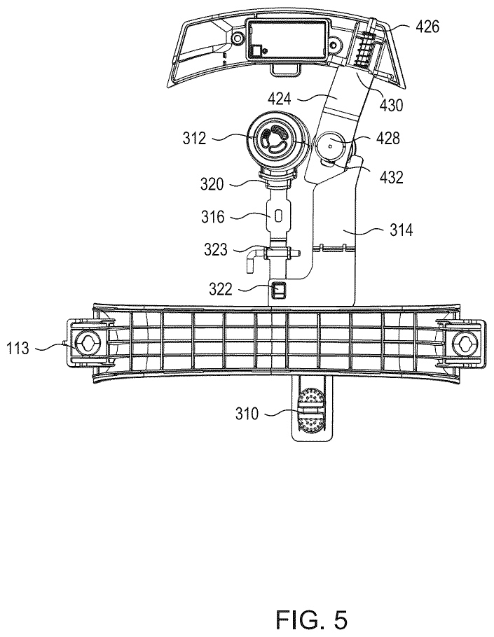

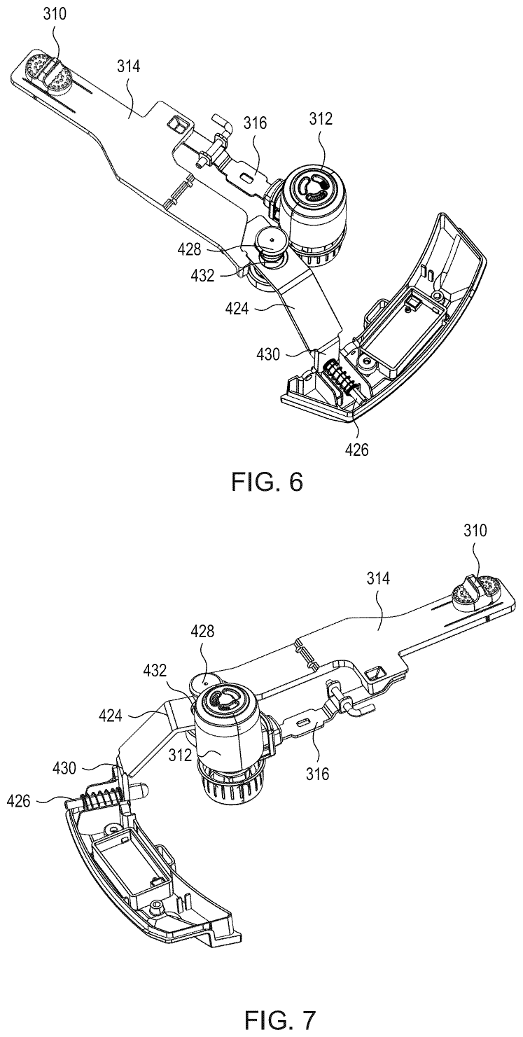

In some implementations, the pressure release valve actuation system is configured to act in cooperation with a pressure lid lock system. Referring to FIGS. 4-7, in some implementations, a pressure lid lock system includes an arm 424, a pin 426, and a pressure plunger 428. When the lid 102 is in an unlocked position relative to the cooker body 104, the pin 426 abuts a side of the cooker body 104 in an extended position. When the lid 102 is rotated to a locked position relative to the cooker body 104, the cooker body 104 defines an aperture for an end of the pin to insert into, thereby locking the lid 102 into position relative to the cooker body 104.

The pin 426 is connected to the arm 424 such that when the pin abuts a side of the cooker body 104 in the extended position, the arm 424 is also positioned in an extended position such that an end 430 of the arm 424 that is connected to the pin 426 is also extended from the side of the cooker body 104. However, when the lid 102 is rotated to a locked position relative to the cooker body 104 and the end of the pin 426 inserts into the cooker body 102, the arm 424 connected to the pin 426 also moves relative to the movement of the pin 426 such that the end 430 of the arm 424 moves closer to the side of the cooker body 104.

During operation, as pressure builds within the cooker body 104, the buildup of pressure causes the pressure plunger 428 to rise into an aperture 432 in the arm 424 and engage the arm 424. When the pressure plunger 428 engages the arm 424 at the aperture 432, the pressure plunger 428 holds the arm 424 in position, thereby also holding the pin 426 connected to the arm 424 in position. It will be appreciated that when the arm 424 and the pin 426 are held in position, the lid 102 is unable to rotate relative to the cooker body 104 due to the end of the pin 426 inserted into the cooker body 104, thereby locking the lid 102 in place.

When the pressure release valve 312 is actuated as described above, the pressure plunger 428 falls as the pressurized air is released from the inner pot 104. As a result, the pressure plunger 428 no longer holds the arm 424 in position and the arm 424 is free to extend away from the end of the lid 102 when the pin 426 is moved into the extended position, thereby allowing the lid 102 to rotate and unlock from the connector body 104.

In some implementations, the pin 426 is actuated, thereby causing the end of the pin 426 to retract from the cooker body 104 by a contour of the cooker body 104, such as a ramp, as the lid 102 rotates counterclockwise with respect to the cooker body 104.

In some implementations, the slider 314 engages with the arm 424 such that as the arm 424 moves to the extended position, the arm 424 pulls the slider 314 into its first position, thereby resetting the pressure release valve actuation system and closing the pressure release valve 312. In the implementations described above, as the arm 424 pulls the slider 314 into its first position, the slider 314 allows the second end 322 of the lever 316 to rise. As a result, the first end 320 of the lever 316 lowers and the pressure release valve 312 lowers from its open position to its closed position.

While implementations of a pressure lid lock system have been described with respect to relative movements of the arm 424, the pin 426, and the pressure plunger 428, and the interaction of the relative movements of the arm 424, the pin 426, and the pressure plunger 428 with respect to relative movements of the switch 310, the pressure release valve 312, the slider 314, and the lever 316 of a pressure release valve actuation system, one of skill in the art will appreciate that other configurations may be used with different relative movements of the arm 424, the pin 426, and the pressure plunger 428 and different relative movements with respect to interaction with the switch 310, the pressure release valve 312, the slider 314, and the lever 316 that similarly result in the locking of a lid to a cooker body and a resetting of the pressure release valve actuation system upon the release of pressurized gas from the electronic pressure cooker.

As discussed above in conjunction with FIGS. 1-7, the present disclosure provides a lid to an electric pressure cooker where a shield is positioned between a switch that a consumer activates to open a pressure release valve and the pressure release valve itself where pressurized gas is released from a cooking vessel of the EPC. Positioning a shield between a switch and a pressure release valve of an electric pressure cooker provides enhanced safety by providing a partial barrier between a hand of a user activating the switch and steam exiting the electric pressure cooker at the pressure release valve.

The foregoing disclosure has been set forth to illustrate the invention and is not intended to be limiting. Since modifications of the disclosed form and implementations incorporating the spirit and substance of the invention may occur to persons skilled in the art, the invention should be construed to include everything within the scope of the appended claims and equivalents thereof.

1. A lid for a cooking appliance, the lid comprising:
a pressure release valve configured to move between an open position and a closed position;
a slider configured to move between a first position and a second position;
a switch in communication with the slider, wherein pressure on the switch in a first direction causes the slider to move between the first position and the second position;
a lever defining a first end and a second end, wherein the first end of the lever is in communication with the pressure release valve and the second end of the lever is in communication with the slider such that movement of the slider between its first position and its second position causes the second end of the lever to lower and the first end of the lever to raise, thereby moving the pressure release valve from the closed position to the open position; and
a shield positioned on an exterior of the lid between the pressure release valve and the switch.

2. The lid of claim 1, wherein the shield comprises a handle.

3. The lid of claim 1, wherein:
the second position of the slider is positioned farther away from the pressure release valve than the first position of the slider.

4. The lid of claim 3, further comprising:
an arm positioned at a side of the lid, the arm configured to move between a first position and a second position, wherein in the second position of the arm, a first end of the arm is farther from an edge of the lid than in the first position of the arm; and
a pin in communication with the arm, the pin configured to hold the arm in the second position until an end of the pin inserts into an aperture;
wherein a second end of the arm is in communication with the slider; and
wherein the arm is configured to move the slider from its second position to its first position as the arm moves from its first position to its second position.

5. The lid of claim 4, further comprising:
a pressure plunger configured to engage the arm and hold the arm in its first position when pressure is applied to the pressure plunger.

6. The lid of claim 5, wherein the pressure plunger is further configuration to cease engagement with the arm when pressure is relieved from the pressure plunger.

7. A lid for a cooking appliance, the lid comprising:
a shield positioned on an exterior of the lid;
a pressure release valve positioned on the lid on a first side of the shield, the pressure release valve configured to move between an open position and a closed position;
a switch positioned on the lid on a second side of the shield that is opposite to the first side of the shield;
a slider in communication with the switch; and
a lever defining a first end and a second end, where the first end of the lever is in communication with the pressure relief valve and the second end of the lever is in communication with the slider;
wherein the switch is configured to, when activated, move the slider such that the slider depresses the second end of the lever, thereby raising the first end of the lever and moving the pressure release valve from the closed position to the open position.

8. The lid of claim 7, wherein a handle defines the shield.

9. The lid of claim 7, further comprising:
an arm configured to move from a position adjacent to an edge of the lid to a position extended from the edge of the lid; and
a pin in communication with the arm, the pin configured to hold the arm in the position extended from the edge of the lid when the pin is not inserted into an aperture;
wherein the arm is in communication with the slider and is configured to move the slider into a position that lowers the first end of the lever when the arm is in the position extended from the edge of the lid.

10. The lid of claim 9, further comprising:
a pressure plunger configured to engage the arm and hold the arm in position when pressure is applied to the pressure plunger.

11. A pressure cooker, comprising:
a cooker body;
an interior pot positioned in an interior of the cooker body;
a lid configured to couple with the cooker body, the lid comprising:
a shield positioned on an exterior of the lid;
a pressure release valve positioned on the lid on a first side of the shield, the pressure release valve in communication with the interior pot and configured to move between an open position and a closed position;
a switch positioned on the lid on a second side of the shield that is opposite to the first side of the shield;
a slider in communication with the switch;
a lever defining a first end and a second end, where the first end of the lever is in communication with the pressure release valve and the second end of the lever is in communication with the slider;
wherein the switch is configured to, when activated, move the slider such that the slider depresses the second end of the lever, thereby raising the first end of the lever and moving the pressure release valve from the closed position to the open position.

12. The pressure cooker of claim 11, wherein a handle positioned on the exterior of the lid defines the shield.

13. The pressure cooker of claim 11, wherein the lid further comprises:
an arm configured to move from a position adjacent to an edge of the lid to a position extended from the edge of the lid; and
a pin in communication with the arm, the pin configured to hold the arm in the position extended from the edge of the lid when the pin is not inserted into an aperture in the cooker body;
wherein the arm is in communication with the slider and is configured to move the slider into a position that lowers the first end of the lever when the arm is in the position extended from the edge of the lid.

14. The pressure cooker of claim 13, wherein the lid further comprises:
a pressure plunger configured to engage the arm and hold the arm in its position adjacent to the edge of the lid when pressure is applied to the pressure plunger.

15. The pressure cooker of claim 14, wherein the pressure plunger is further configuration to cease engagement with the arm when pressure is relieved from the pressure plunger.
